(19) United States
(12) Patent Application Publication
(10) Pub. No.: US 2009/0059094 A1
(43) Pub. Date: Mar. 5, 2009

(54) Apparatus and method for overlaying image in video presentation system having embedded operating system

(75) Inventors: Jin-wook Yi, Seongnam-si (KR); Jeong-han Yoon, Seongnam-si (KR); Suk-bong Um, Seongnam-si (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 12/214,868

(22) Filed: Jun. 23, 2008

(30) Foreign Application Priority Data
Sep. 4, 2007 (KR) 10-2007-0089401
Sep. 4, 2007 (KR) 10-2007-0089402

(51) Int. Cl. H04N 9/31

(52) U.S. Cl. 348/744; 348/E09.025

(57) ABSTRACT

A video presentation system is provided for outputting a document and/or multimedia image file as well as a live image on one display unit. The system integrates an embedded system for controlling devices with a video presentation device, which is an optical image electronic device. The video presentation system integrating an embedded operating system (OS) includes: a video presenting unit processing a generated first image or a received second image to generate a signal that can be displayed, and outputting the generated signal, or processing the first image and the second image to generate a signal that can be displayed, by overlaying the images, and transmitting the captured first image or a part of the image; and an embedded unit transmitting the overlay information and the second image to the video presenting unit through periodic communication with the video presenting unit, and receiving the captured first image.

### CROSS-REFERENCE TO RELATED PATENT APPLICATIONS

This application claims the benefit of Korean Patent Application Nos. 10-2007-0089401 and 10-2007-0089402, filed on Sep. 4, 2007 in the Korean Intellectual Property Office, the disclosures of both being incorporated herein in their entirety by reference.

### BACKGROUND OF THE INVENTION

1. Field of the Invention

The present invention relates generally to a video presentation system. More particularly, the present invention relates to a video presentation system having an embedded operation system (OS), and a method for overlaying an image in the video presentation system having an embedded operation system (OS). In the method the video presentation system signal-processes an image generated in a video presentation device that is optical image electronic equipment in which an embedded system for controlling a device is integrated, and an image received in the embedded system to overlay the images and display the overlay image using a single graphic engine.

2. Description of the Related Art

In general, a video presenting device is an electronic apparatus for photographing an object with a charge-coupled device (CCD) camera and displaying the image through a monitor. As a replacement for overhead projectors, the video presenting device is widely used for academic and industrial purposes. In particular, by combining a lens (e.g., a microscope lens) capable of magnifying an actual object with a CCD camera picking up an image of an object disposed on the video presenting device, an image magnifying a minute object can be displayed by connecting the video presenting device to a computer with a monitor.

An embedded system is a computing system embedded in another device as an integral part of the other device. Unlike ordinary computers that can perform a multitude of various functions, the embedded system performs only a computing job for a specific predetermined purpose assigned to the device into which the embedded system is integrated. For this, the embedded system has a central processing unit (CPU) and an operating system (OS) so that the embedded system can execute a specific application with the OS, thereby performing a predetermined job. In general, embedded systems are used in order to control military equipment, industrial equipment and communication equipment. An embedded system can provide a graphic user interface (GUI) while performing a predetermined job. A GUI is an interface displaying a menu. An embedded system providing a GUI stores a GUI application for providing the GUI, and GUI image data for expressing icons or menus. When a user requests a GUI display, the embedded system executes the GUI application by using the OS, thereby displaying icons or menu images corresponding to the GUI image data.

Generally, the concept of a video presenting device relates to magnifying a document or object by using a projector in a place of education, a conference, and/or a presentation. The video presenting device transmits an image of the document or object to a personal computer (PC) through a high-speed serial bus such as a universal serial bus (USB). Accordingly, in order to output an electronic document and/or multimedia file, a PC connected to or in communication with a display device is necessarily required, and the video presenting device is used while being recognized as an auxiliary apparatus for a PC.

Since a conventional presentation system is defined by the combination of a projector, PC and video presenting device, accordingly, input and output, and manipulation are inconvenient, and the purchasing cost increases.

### SUMMARY OF THE INVENTION

The present invention provides a video presentation system having an embedded operating system (OS) in which, by integrating hardware related to the embedded OS with a video presenting device, a variety of PC files can be reproduced (i.e., displayed) in addition to outputting live images. Furthermore, two images from different sources (e.g., such as an actual live image from the video presenting device's CCD and a PC file image) can be overlaid and output in a single output.

The present invention also provides a video presentation system having an embedded OS in which, by integrating hardware related to the embedded OS with a video presenting device, live still images and/or moving pictures taken in the video presenting device may be captured and stored in the embedded system.

According to an aspect of the present invention, there is provided a video presentation system including: a video presenting unit processing either a generated first image or a received second image to generate a signal that can be displayed, and outputting the generated signal, or processing a first image and a second image to overlay the first and second images and generate a signal that can be displayed as an overlaid image; and an embedded unit transmitting the overlay information and the second image to the video presenting unit through periodic communication with the video presenting unit, and receiving the captured first image.

According to another aspect of the present invention, there is provided a video presentation system which is an image overlay system, the video presentation system including: a video presenting unit generating a live image, and receiving a document and/or multimedia image and overlay information, and according to the overlay information, overlaying the live image and the document and/or multimedia image and outputting the result as a display signal; and an embedded unit transmitting the document and/or multimedia image to the video presenting unit through periodic communication with the video presenting unit, and if an overlay is requested by an internal input unit, transmitting the overlay information to the video presenting unit.

According to another aspect of the present invention, there is provided a video presentation system which is an image overlay system, the video presentation system including: a video presenting unit generating a live image, receiving a document and/or multimedia image, and if an overlay is request by an internal input unit, receiving overlay information, and according to the overlay information, overlaying the live image and the document and/or multimedia image and outputting the result as a display signal; and an embedded unit transmitting the document and/or multimedia image and the overlay information to the video presenting unit through periodic communication with the video presenting unit.

According to another aspect of the present invention, there is provided a video presentation system for capturing and storing an image, the video presentation system including: a video presenting unit storing a live image captured by using an optical unit, and transmitting a captured still image among the store live images according to a first store signal, or signal-processing and transmitting all the stored live images according to a second store signal; and an embedded unit periodically communicating with the video presenting unit, and transmitting the first store signal and the second store signal to the video presenting unit, and receiving a captured still image or signal-processed live image from the video presenting unit.

According to another aspect of the present invention, there is provided a method of operating a video presentation system for overlaying a generated live image and a received document and/or multimedia image with a video presenting unit signal-processing the live image and/or the document and/or multimedia image, and displaying the signal, and an embedded unit transmitting the document and/or multimedia image to the video presenting unit through periodic communication with the video presenting unit, the method including: the embedded unit requesting the video presenting unit to overlay the live image and the document and/or multimedia image; the embedded unit transmitting, together with the request, overlay information, including the size and position of an image to be overlaid, to the video presenting unit; and the video presenting unit receiving the overlay request signal and the overlay information, overlaying the live image and the document and/or multimedia image and displaying the overlaid image.

According to another aspect of the present invention, there is provided a method of operating a video presentation system for overlaying a generated live image and a received document and/or multimedia image with a video presenting unit signal-processing the live image and/or the document and/or multimedia image, and displaying the signal, and an embedded unit transmitting the document and/or multimedia image to the video presenting unit through periodic communication with the video presenting unit, the method including: if an image overlay is requested by the video presenting unit, requesting the embedded unit to transmit overlay information including the size and position of an image to be overlaid; and if the overlay information from the embedded unit is received, overlaying the live image and the document and/or multimedia image according to the overlay information and displaying the overlaid image.

According to another aspect of the present invention, there is provided a method of operating a video presentation system for storing a generated live image with a video presenting unit signal-processing the live image and/or a received document and/or multimedia image, and displaying the signal, and an embedded unit transmitting the document and/or multimedia image to the video presenting unit through periodic communication with the video presenting unit, the method including: the video presenting unit sequentially storing the live images; the video presenting unit receiving a still image capture signal of the embedded unit, and stopping the sequential storing; the video presenting unit transmitting a live image frame corresponding to a time when the still image capture signal is received, to the embedded unit; and the embedded unit storing the received live image frame in a portable storage unit or transmitting the live image frame to the outside through a network module.

According to another aspect of the present invention, there is provided a method of operating a video presentation system as a method of storing a generated live image with a video presenting unit signal-processing the live image and/or a received document and/or multimedia image, and displaying the signal, and an embedded unit transmitting the document and/or multimedia image to the video presenting unit through periodic communication with the video presenting unit, the method including: the video presenting unit sequentially storing the live images; the video presenting unit receiving a moving picture store signal of the embedded unit, scaling down the whole live images; the video presenting unit transmitting all the scaled-down live images to the embedded unit; and the embedded unit storing all the received scaled-down live images in a portable storage unit or transmitting to the outside through a network module.

According to an aspect of the present invention, there is provided an image overlay apparatus comprising: a video presenting unit, if a generated first image and a received second image are selected as a main image and a second image, overlaying a predetermined size of the sub image over the main image and outputting an overlaid image; and an embedded unit transmitting overlay information and the second image to the video presenting unit by periodic communication with the video presenting unit.

According to another aspect of the present invention, there is provided a method of operating a system including a video presenting unit signal-processing a generated first image and a received second image and displaying the signal-processed first and second images, and an embedded unit transmitting the second image to the video presenting unit by periodic communication with the video presenting unit, the method comprising: receiving a signal for selecting a main image and a sub image with regard to the first image or the second image from the video presenting unit or the embedded unit; the embedded unit transmitting overlay information including a size and position of an image to be overlaid to the video presenting unit; and the video presenting unit processing the first image or the second image that is selected as the main image as a signal that can be displayed, signal-processing the first image or the second image that is selected as the sub image according to the overlay information, overlaying the sub image over the main image, and outputting the overlaid image.

According to another aspect of the present invention, there is provided a image overlay apparatus comprising: a video presenting unit, if it is requested to overlay a generated first image and a received overlay image, receiving a signal for selecting a main image and a sub image with regard to the first image or the second image, displaying the sub image on a predetermined size of a virtual window, overlaying the sub image over the main image, and outputting the overlaid image; and an embedded unit transmitting the second image to the video presenting unit by periodic communication with the video presenting unit, generating the virtual window on which the sub image is to be displayed according to an overlay request, and transmitting the virtual window to the video presenting unit.

According to another aspect of the present invention, there is provided a method of operating a system including a video presenting unit signal-processing a generated first image and a received second image and displaying the signal-processed first and second images, and an embedded unit transmitting the second image to the video presenting unit through a periodic communication with the video presenting unit, the method comprising: if an image overlay is requested, receiving a signal for selecting a main image and a sub image with regard to the first image and the second image from the embedded unit; receiving a virtual window from the embedded unit and displaying the virtual window; and displaying the sub image on a predetermined size of the virtual window, overlaying the sub image over the main image, and displaying the overlaid image.

According to the present invention as described above, by integrating hardware related to an embedded OS with a video presenting device, a system that cannot exceed the functional range of a PC is provided. Using the system, live images and/or electronic documents and/or multimedia images are output. In this way presentation can be conveniently performed without a PC.

Also, when two images (actual live image and PC file image) generated in different sources are overlaid in one output signal and output, the overlay function is implemented in a final output end without having to utilize a separate device or image processing application. Accordingly, even when multimedia images are output as reproduction of moving pictures, two images can be overlaid and output without a separate application program.

In addition, live still images and/or moving pictures photographed in a video presenting device can be captured and stored in the embedded system, thereby reducing load on the CPU of the embedded system and enabling implementation of real-time processing.

In relation to education markets, document and/or multimedia files are reproduced without a PC thereby allowing lectures to be performed by utilizing a variety of audio-visual education materials together with live images. For example, when a biology class is taught by observing an ant nest or the anatomy of a frog, related theoretical backgrounds can be explained with document images, and the ant nest or frog actually prepared can be photographed as a live image on the spot and displayed while being overlaid with the document images. In this way, the education effect can be maximized, and all materials required for a modernized classroom can be used by reproducing moving picture audio-visual education materials which are already prepared.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram illustrating a video presentation system video presentation system with an embedded operating system (OS) according to an embodiment of the present invention;

FIG. 2 is an example block diagram illustrating features of the video presentation system illustrated in FIG. 1 according to an embodiment of the present invention;

FIG. 3 is a block diagram illustrating a structure of an image overlay apparatus in the system illustrated in FIG. 2 according to an embodiment of the present invention;

FIG. 4 is a flowchart illustrating operations of a method of overlaying an image according to an embodiment of the present invention;

FIG. 5 is a diagram illustrating an example of an overlay image reproduced by a display unit illustrated in FIGS. 3 and 4 according to an embodiment of the present invention;

FIG. 6 is a block diagram illustrating a structure of an image overlay apparatus in the system illustrated in FIG. 2 according to another embodiment of the present invention;

FIG. 7 is a flowchart illustrating operations of a method of overlaying an image according to another embodiment of the present invention;

FIG. 8 is a block diagram illustrating a structure of an image pickup/storage apparatus in the system illustrated in FIG. 2 according to an embodiment of the present invention;

FIG. 9 is a flowchart illustrating operations of a method of capturing and/or storing a still image according to an embodiment of the present invention; and

FIG. 10 is a flowchart illustrating operations of a method of capturing and/or storing moving pictures according to an embodiment of the present invention.

FIG. 11 is a block diagram illustrating a structure of an image overlay apparatus in the system illustrated in FIG. 2 according to an embodiment of the present invention;

FIG. 12 is a flowchart illustrating operations of a method of overlaying an image according to an embodiment of the present invention;

FIG. 13 illustrates signal processing of a live image illustrated in FIGS. 11 and 12 according to an embodiment of the present invention;

FIG. 14 illustrates signal processing of a document/multimedia image illustrated in FIGS. 11 and 12 according to an embodiment of the present invention;

FIG. 15 is a flowchart illustrating operations of a method of overlaying an image according to another embodiment of the present invention; and

FIG. 16 illustrates an overlaid virtual window generated on a display unit according to an embodiment of the present invention.

### DETAILED DESCRIPTION OF THE INVENTION

The present invention will now be described more fully with reference to the accompanying drawings, in which exemplary embodiments of the invention are shown.

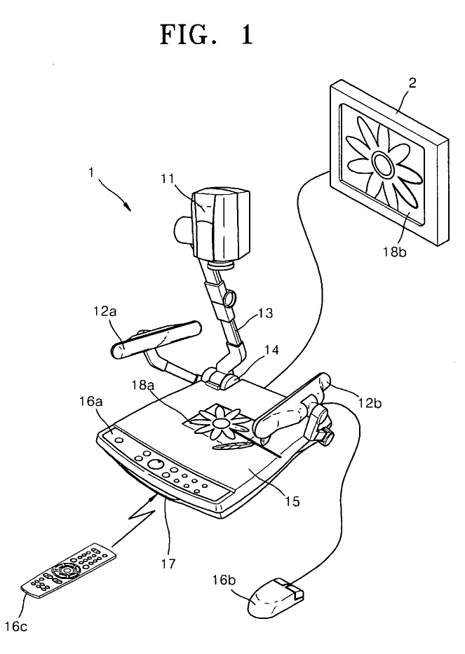

FIG. 1 is a diagram illustrating a video presentation system with an embedded operating system (OS) according to an embodiment of the present invention. The video presentation system includes a video presenting unit 1 into which an embedded unit is integrated, and a display unit 2 for displaying an object image 18b.

In the current embodiment, the video presenting unit 1 includes an image sensing unit 11, lighting apparatuses 12a and 12b, a support 13, a locking button 14, an object base 15, an input unit including a key input unit 16a, a mouse 16b, and a remote controller 16c, a remote reception unit 17 and an object 18a.

The image sensing unit 11 which can move forward and backward, and rotate, includes an optical system and a photoelectric conversion unit. The optical system for optically processing light reflected from the object 18a has a lens unit and a filter unit. The photoelectric conversion unit formed with a CCD or complementary metal-oxide semiconductor (CMOS) converts incident light, which is reflected from an object (e.g., object 18a), into an electric analog signal.

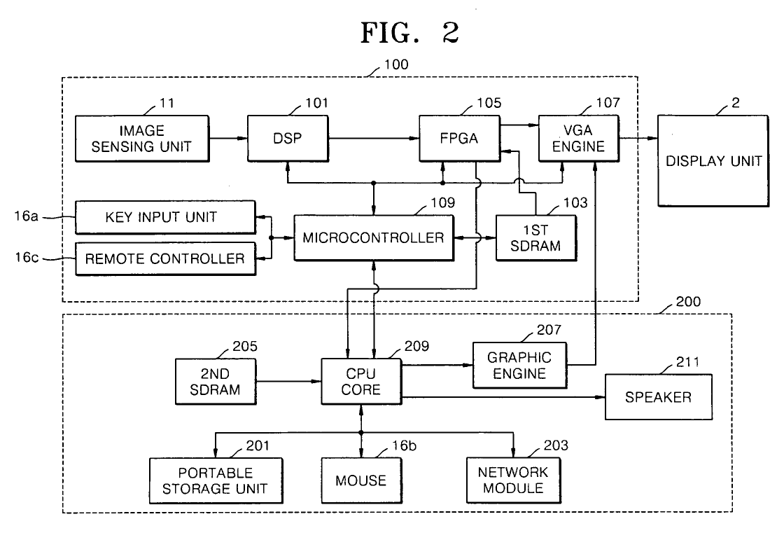

A user can move the support 13 by pressing the locking button 14. Another lighting apparatus (i.e., a backlight) may be configured below the object base 15. The key input unit 16a or the mouse 16b may be used to control operation of each unit (100, 200 FIG. 2) of the video presenting unit 1 and the lighting apparatuses 12a and 12b according to the user's manipulation. Meanwhile, the user inputs a control signal to the remote reception unit 17 by manipulating the remote controller 16c, thereby controlling operation of each of the image sensing unit 11 and the lighting apparatuses 12a and 12b.

FIG. 2 is a diagram illustrating an internal structure of the video presentation system illustrated in FIG. 1 according to an embodiment of the present invention. The video presentation system includes a display unit 2, a video presenting unit 100, and an embedded unit 200. By integrating the embedded unit 200 with the video presenting unit 100 a variety of PC files can be reproduced (i.e., displayed) in addition to outputting live images. Furthermore, two images that may be from different sources (e.g., an actual live image from image sensing unit 11 and a PC file image) can be overlaid on one output (e.g., signal) and output. Also, live still images and/or moving pictures photographed in the video presenting unit 100 can be captured and stored in the embedded unit 200.

In the current embodiment, the video presenting unit 100 includes an image sensing unit 11, a key input unit 16a and a remote controller 16c as an input unit, a digital signal processor (DSP) 101, a first synchronous dynamic random access memory (SDRAM) 103, a field programmable gate array (FPGA) 105, a video graphic array (VGA) engine 107, and a microcontroller 109.

In the current embodiment, the embedded unit 200 includes a mouse 16b as an input unit, a portable storage unit 201, a network module 203, a second SDRAM 205, a graphic engine 207, a CPU core 209, and a speaker 211.

The microcontroller 109 of the video presenting unit 100 and the CPU core 209 of the embedded unit 200 perform periodic communication, thereby transmitting and receiving data therebetween. By using a vertical synchronization signal of a CCD (of image sensing unit 11) as a period, data up to 48 bytes is periodically exchanged.

Operation of the video presenting unit 100 will now be explained. The image sensing unit 11 optically processes light from the object 18a, thereby converting the light into an analog signal.

The DSP 101 converts the analog live image signal of the object 18a into a digital signal and performs a variety of signal processing on the image signal for display so as to display the object image. For example, the DSP 101 may remove a black level by a dark current generated in a CCD or CMOS sensitive to a temperature change, and performs gamma correction for encoding information according to the nonlinearity of human vision. The DSP 101 may also perform color filter array (CFA) interpolation in which a Bayer pattern implemented by RGRG lines and GBGB lines of gamma-corrected predetermined data is interpolated with RGB lines. Still further, the DSP 101 may convert the interpolated RGB signal into a YUV signal, and remove noise by performing edge compensation in which a Y signal is filtered by a high pass filter to make an image clearer, and color correction for correcting color values of U and V signals by using a standard color coordinate system.

The first SDRAM 103 is a frame memory for storing in units of frames a live image which is signal-processed in the DSP 101.

The FPGA 105 is a memory control unit that retrieves the live image stored in units of frames in the first SDRAM 103, and provides retrieved images to the VGA engine 107. Also, according to control by the microcontroller 109 which receives an image capture signal of the embedded unit 200, the FPGA 105 scales down image frame data or moving pictures and transmits the scaled down image frame data to the CPU core 209.

The VGA engine 107 is an image output unit that converts the live image received from the FPGA 105 into an analog composite video signal, thereby outputting the signal to the display unit 2. Also, the VGA engine 107 converts a document and/or multimedia file image, which is received from the embedded unit 200, into an analog composite video signal and outputs the signal to the display unit 2. The VGA engine 107 performs signal processing to scale or to convert the frame rates of the frame image, which is received from the FPGA 105, and the document and/or multimedia image received from the embedded unit 200, and then overlays the images, converts the overlaid image into an analog composite video signal, and outputs the signal to the display unit 2. According to another embodiment, the VGA engine 107 displays a sub-image (for example, a live image) on a predetermined size virtual window transmitted from the embedded unit 200, overlays the sub-image on a main image (for example, a document/multimedia image), and outputs the overlaid image on the display unit 2.

The microcontroller 109, which functions as a first control unit in the video presentation system according to the current embodiment, controls the operation of the video presenting unit 100, and periodically communicates with the embedded unit 200. In particular, the microcontroller 109 receives an overlay request signal from the key input unit 16a and the remote controller 16c, and according to overlay information received from the embedded unit 200, the microcontroller 109 controls the VGA engine 107 so that the frame image received from the FPGA 105 and the document and/or multimedia image received from the embedded unit 200 can be overlaid. Here, the overlay information is the size and position data of an image to be overlaid. Also, the microcontroller 109 receives a signal from the embedded unit 200 that commands the video presenting unit 100 to capture and store a still image or a moving picture. According to such an image capture and storage signal, the microcontroller 109 controls the FPGA 105 so that the image processed in the FPGA 105 can be transmitted to the CPU core 209 of the embedded unit 200. If an unexpected software error occurs, the microcontroller 109 can reset the CPU core 209 of the embedded unit 200.

Next, the embedded unit 200 will now be explained. The portable storage unit 201, which in some embodiments may be detachable, stores various files including documents and/or multimedia file images. Also, the portable storage unit 201 stores still images and moving pictures related to live images transmitted from the FPGA 105.

The network module 203 receives document and/or multimedia file images from the outside (e.g., another device including but not limited to a PC, PDA, server, etc.). Also, the network module 203 is configured to transmit to the outside still images and moving pictures related to live images stored in and retrieved from the FPGA 105.

The second SDRAM 205 stores the document and/or multimedia file images of the portable storage unit 201, or document and/or multimedia file images received from the network module 203, and still images or moving pictures related to live images received from the FPGA 105 according to control by the CPU core 209.

According to control by the CPU core 209, the graphic engine 207 receives files such as document and/or multimedia file images stored in the second SDRAM 205, converts the files into digital images, and outputs the images to the VGA engine 107.

The CPU core 209, which functions as a second control unit in the video presentation system according to the current embodiment, controls the operation of the embedded unit 200, and periodically communicates with the microcontroller 109 of the video presenting unit 100.

In particular, the CPU core 209 receives an overlay request signal from the mouse 16b and transmits the signal to the microcontroller 109. When an image is overlaid, the CPU core 209 generates overlay information (the size and position data of an image to be overlaid) and transmits the information to the microcontroller 109. Also, the CPU core 209 controls an audio signal of an image displayed on the display unit 2 and outputs the audio signal to the speaker 211. According to another embodiment, the CPU core 209 receives an overlay request signal from the mouse 16b, generates a virtual window on which a sub-image is to be displayed, and transmits the virtual window to the microcontroller 109. The CPU core 209 receives a virtual window change signal (drag, size change) of the mouse 16b, and transmits virtual window change information according to the virtual window change signal to the microcontroller 109. A virtual window change can be displayed through a window message.

When an image is overlaid, the graphic engine 207 or the CPU core 209 that controls the reproduction of the electronic/multimedia image cannot be informed of whether an overlay screen exists since an overlay function is performed in the VGA engine 107 under the control of the microcontroller 109. Thus, if the microcontroller 109 does not inform the CPU core 209 of whether the overlay screen exists, the graphic engine 207 cannot be informed of whether the overlay screen exists. This can be overcome by communication with a vertical synchronizing signal as a period.

Also, in relation to live images of the video presenting unit 100, the CPU core 209 may transmit to the microcontroller 109 a capture signal for capturing and storing a still image or a moving picture. The CPU core 209 controls the capturing of still images and moving pictures related to live images received from the FPGA 105. Further, the CPU core 209 controls the storing of those captured still images and moving pictures relative to the portable storage unit 201 or, alternatively, transmission of captured images/pictures to the outside through the network module 203.

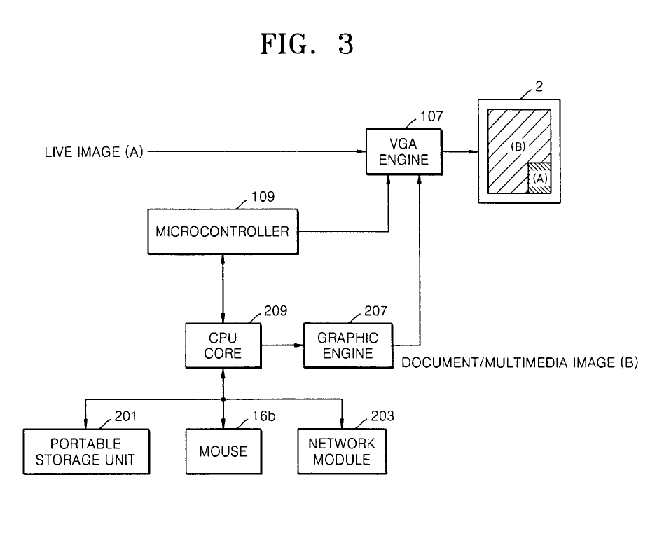

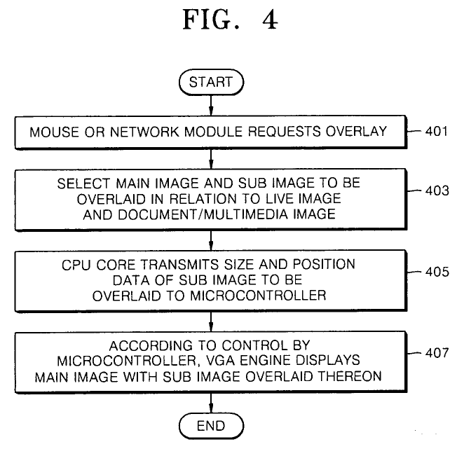

FIG. 3 is a block diagram illustrating a structure of an image overlay apparatus in the system illustrated in FIG. 2 according to an embodiment of the present invention, and FIG. 4 is a flowchart illustrating operations of a method of overlaying an image according to an embodiment of the present invention.

The image overlay apparatus and method illustrated in FIGS. 3 and 4 are hereafter described for explaining overlay performed by using the CPU core 209 as a host. The overlay performed by using the CPU core 209 as a host means that an image overlay function of the present system and method is performed using the CPU core 209 as a main control unit of a control subsystem defined by microcontroller 109 and CPU core 209. Furthermore, the image overlay function is performed according to an overlay request by the mouse 16b or as received from the outside by the network module 203.

Referring to FIG. 3, one embodiment of an overlay apparatus includes a display unit 2, a mouse 16b, a VGA engine 107, a microcontroller 109, a portable storage unit 201, a network module 203, a graphic engine 207, and a CPU core 209 as a host. A detailed explanation of the elements illustrated in FIG. 3 is the same as described above, and therefore will be omitted here.

The method of overlaying an image illustrated in FIG. 4 will now be explained in association with FIG. 3.

First, the CPU core 209 receives an overlay request signal from the mouse 16b or the network module 203 in operation 401.

Then, the CPU core 209 receives a signal for selecting a main image and a sub image to be overlaid on the main image. Each of the main image and the sub image are selected to be one of a live image (A) and a document and/or multimedia image (B) in operation 403. That is, the selecting signal designates or defines which one of the images (A), (B) is to be set as the main image and which one of the images (A), (B) is to be set as the sub image.

The live image (A) is input to the VGA engine 107 through the image sensing unit 11, the DSP 101, and the FPGA 105 as shown in FIG. 2. The document and/or multimedia image (B), which may be stored in the portable storage unit 201 or received through the network module 203, is input to the VGA engine 107 through the graphic engine 207. The live image (A) may be selected as a main image and the document and/or multimedia image (B) may be selected as a sub image. Also, the document and/or multimedia image (B) may be selected as a main image and the live image (A) may be selected as a sub image to be overlaid. For convenience of explanation, in the current embodiment the document and/or multimedia image (B) is selected as a main image and the live image (A) is selected as a sub image to be overlaid. This configuration of images (A) and (B) is shown on the display unit 2 illustrated in FIG. 3.

If selection of the main image and the sub image to be overlaid is finished, the CPU core 209 transmits the size and position data of the sub image, which is to be overlaid, to the microcontroller 109 in operation 405.

The microcontroller 109, which receives the size and position data of the sub image to be overlaid, controls an image overlay function of the VGA engine 107. The VGA engine 107 overlays the live image (A) on the document and/or multimedia image (B) and displays the resulting image.

The microcontroller 109 controls the VGA engine 107, and transmits the position and size data of the live image (A), which is to be overlaid, to the VGA engine 107. Upon receiving the data relative to image (A), the VGA engine 107 scales the live image (A) to fit the received size and buffers the image, thereby processing the image signal as a final overlay image to be displayed. The VGA engine 107 converts the document and/or multimedia image (B) into an analog composite video signal, and converts the live image (A), which is to be overlaid on the document and/or multimedia image (B), by performing signal processing such that images (A) and (B) are converted into an analog composite video signal that is output to the display unit 2.

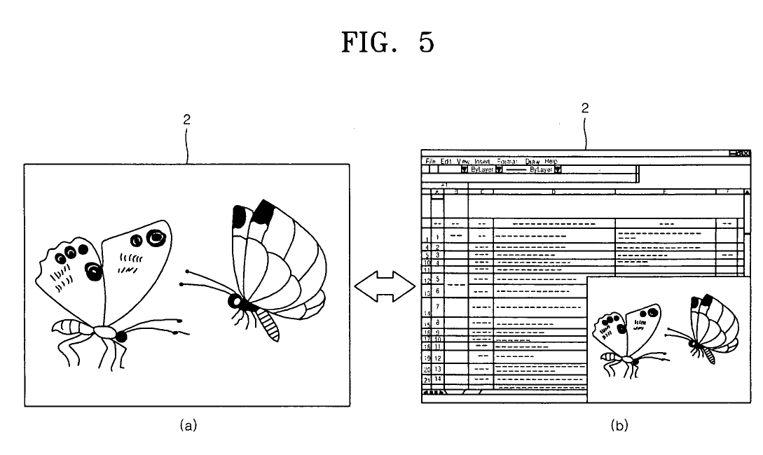

FIG. 5 is a diagram illustrating an example of an overlay image reproduced by the display unit 2 illustrated in FIG. 3 according to an embodiment of the present invention. Portion (a) of FIG. 5 illustrates a live image (i.e., an image output from image sensing unit 11) being displayed on the display unit 2. Portion (b) of FIG. 5 illustrates that the live image (A) is overlaid and displayed on the document and/or multimedia image (B), after the live image's position and size are changed by being signal processed in the VGA engine 107.

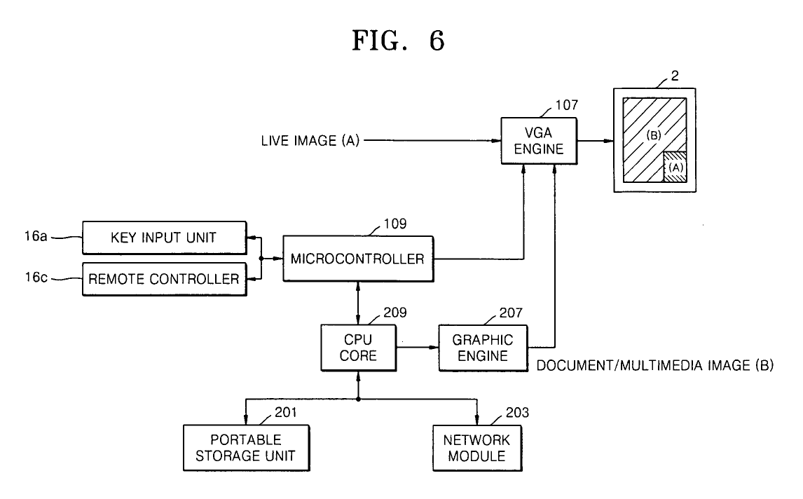

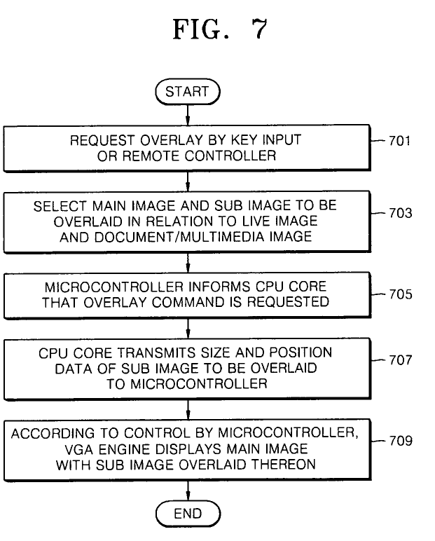

FIG. 6 is a block diagram illustrating another embodiment of an image overlay apparatus of the system illustrated in FIG. 2, and FIG. 7 is a flowchart illustrating operations of a method of overlaying an image according to another embodiment of the present invention.

The image overlay apparatus and method illustrated in FIGS. 6 and 7 are hereafter described for explaining overlay performed by using the microcontroller 109 as a host. The overlay performed by using the microcontroller 109 as a host means that an image overlay function of the present system and method is performed using the microcontroller 109 as a main control unit of a control subsystem defined by microcontroller 109 and CPU core 209. Furthermore, the image overlay function is performed according to an overlay request by the key input unit 16a or the remote controller 16c.

Referring to FIG. 6, the overlay apparatus with the microcontroller 109 as a host includes a display unit 2, a key input unit 16a, a remote controller 16c, a VGA engine 107, a microcontroller 109, a portable storage unit 201, a network module 203, a graphic engine 207, and a CPU core 209. A detailed explanation of the elements illustrated in FIG. 6 is the same as described above, and therefore will be omitted here.

The method of overlaying an image illustrated in FIG. 7 will now be explained in association with FIG. 6.

First, the microcontroller 109 receives an overlay request signal from the key input unit 16a or the remote controller 16c in operation 701.

Then, the microcontroller 109 receives a signal for selecting a main image and a sub image to be overlaid in relation to a live image (A) and a document and/or multimedia image (B) in operation 703.

The live image (A) is input to the VGA engine 107 through the image sensing unit 11, the DSP 101, and the FPGA 105 as shown in FIG. 2. The document and/or multimedia image (B), which may be stored in the portable storage unit 201 or received from the outside via the network module 203, is input to the VGA engine 107 through the graphic engine 207. As described above, it is assumed that the document and/or multimedia image (B) is selected as a main image and the live image (A) is selected as a sub image to be overlaid.

If selection of the main image and the sub image to be overlaid is finished in operation 703, the microcontroller 109 notifies the CPU core 209 in operation 705 that an overlay command is requested.

The microcontroller 109 and the CPU core 209 perform periodic communication, thereby transmitting and receiving data therebetween. By using a vertical synchronization signal of a CCD as a period, data up to 48 bytes is periodically exchanged. In this way, by using the vertical synchronization signal of the CCD as a period, the microcontroller 109 notifies the CPU core 209 that the overlay command is requested.

The CPU core 209 after having receiving the overlay command request signal from the microcontroller 109 transmits the size and position data of a sub image to be overlaid to the microcontroller 109 in operation 707.

The microcontroller 109, which receives the size and position data of the sub image to be overlaid, controls an image overlay function of the VGA engine 107. The VGA engine 107 overlays the live image (A) on the document and/or multimedia image (B) and displays the resulting image.

The microcontroller 109 controls the VGA engine 107, and transmits the position and size data of the live image (A) to be overlaid to the VGA engine 107. Upon receiving the data relative to image (A), the VGA engine 107 scales the live image (A) to fit the received size and buffers the image, thereby processing the signal as a final overlay image to be displayed. The VGA engine 107 converts the document and/or multimedia image (B) into an analog composite video signal, and converts the live image (A), which is to be overlaid on the document and/or multimedia image (B), through signal processing into an analog composite video signal and outputs the converted signals to the display unit 2. Portion (b) of FIG. 5 illustrates that the live image (A) is overlaid and displayed on the document and/or multimedia image (B), after the live image's position and size are changed by being signal processed in the VGA engine 107.

One feature of the image overlay apparatus and method illustrated in FIGS. 3 through 7 is that the CPU core 209 is rarely overloaded, because an image overlay is processed in the final output end, i.e., the VGA engine 107, without having to utilize substantial internal process of the CPU core 209. Accordingly, in order to output a variety of documents or multimedia images, the CPU core 209 does not need to execute a separate application program, and only needs to transmit the documents and/or multimedia images to the VGA engine 107. In this way, the CPU core 209 is rarely overloaded and two image overlay is enabled.

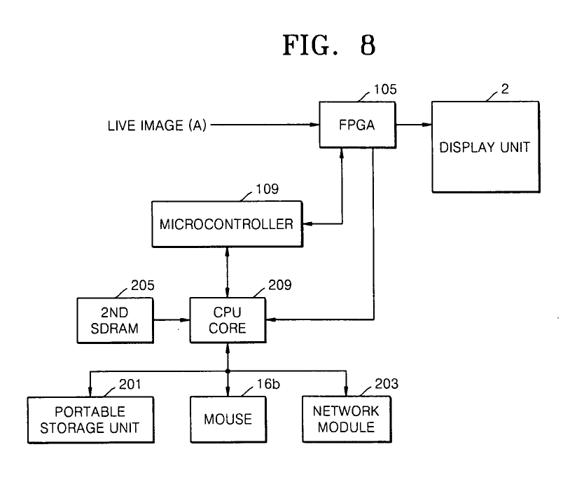

FIG. 8 is a block diagram illustrating a structure of an image pickup/storage apparatus in the system illustrated in FIG. 2 according to an embodiment of the present invention. The image pickup/storage apparatus includes a display unit 2, a mouse 16b, an FPGA 105, a microcontroller 109, a portable storage unit 201, a network module 203, a second SDRAM 205, and a CPU core 209. A detailed explanation of the elements illustrated in FIG. 8 is the same as described above, and therefore will be omitted here.

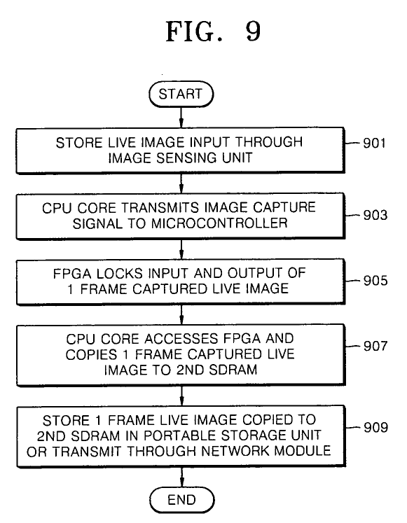

FIG. 9 is a flowchart illustrating operations of a method of capturing and/or storing a still image according to an embodiment of the present invention, which will be explained in association with FIG. 8.

The video presenting unit 100 stores a live image input through the image sensing unit 11 (FIG. 2) in the FPGA 105 in operation 901.

With the image input being picked up by the image sensing unit 11, the DSP 101 performs a signal processing process for display according to control by the microcontroller 109, and then, the image is stored in a frame buffer of the FPGA 105.

In this process, the CPU core 209 transmits an image capture signal to the microcontroller 109 in operation 903.

The CPU core 209, which may receive the image capture signal from the mouse 16b, transmits a signal (e.g., the image capture signal or a control signal relative thereto) to the microcontroller 109 using a vertical synchronization signal of a CCD as a period.

The microcontroller 109 receiving the image capture signal controls the operation of the FPGA 105, and the FPGA 105 locks input and output of one frame of the live image stored in the frame buffer at a time when the capture signal is received.

One reason why the FPGA 105 locks the input and output of the frame buffer at the time when the capture signal is received is because a live image signal is continuously input through the image sensing unit 11. Accordingly, if the input and output of the frame buffer is not locked, storing of the live image at the time when the capture signal is received may not be performed.

Then, the CPU core 209 accesses the FPGA 105 and copies the captured image to the second SDRAM 205 in operation 907.

If one frame of the live image stored in the frame buffer is stored at the time when the capture signal is received, the microcontroller 109 notifies the CPU core 209 of the storing and the CPU core 209 accesses the FPGA 105 and copies the one frame of the live image stored in the frame buffer into the second SDRAM 205.

Then, the one frame of the live image copied into the second SDRAM 205 is stored in the portable storage unit 201 or transmitted to the outside through the network module 203 according to control by the CPU core 209 in operation 909.

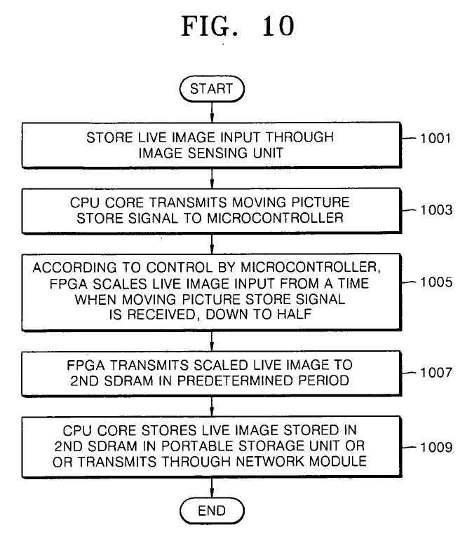

FIG. 10 is a flowchart illustrating operations of a method of capturing and/or storing moving pictures according to an embodiment of the present invention, which will now be explained in association with FIG. 8.

The video presenting unit 1 (FIG. 1) stores a live image, which is input through the image sensing unit 11, in the FPGA 105 in operation 1001.

The image input through the image sensing unit 11 is signal-processed in the DSP 101 (FIG. 2) for display according to control by the microcontroller 109, and then, is stored in the frame buffer of the FPGA 105.

In this process, the CPU core 209 transmits a moving picture store signal to the microcontroller 109 in operation 1003.

The CPU core 209 receives the moving picture store signal, which may be from the mouse 16b, and transmits a signal (e.g., the moving picture store signal or a control signal relative thereto) to the microcontroller 109 with a vertical synchronization signal of the CCD as a period.

Upon receiving the moving picture store signal, the microcontroller 109 controls the operation of the FPGA 105 so that the FPGA 105 scales the live image input from a time when the moving picture store signal is received, down to half the size in operation 1005. For example, the FPGA 105 scales a super extended graphic array (SXGA) 1280×1024 sized/formatted image down to a VGA 640×480 image.

Then, the FPGA 105 transmits the scaled-down moving picture to the second SDRAM 205 using the vertical synchronization signal of the CCD as a period in operation 1007.

In this case, when the FPGA 105 transmits the scaled-down moving picture to the second SDRAM 205, the start and end of each frame are notified by interrupt signals in transmission of each frame.

Then, the moving picture transmitted to the second SDRAM 205 is MPEG encoded in the CPU core 209, after which the moving picture is stored in the portable storage unit 201 or transmitted to the outside through the network module 203 in operation 1009.

One reason why the methods illustrated in FIGS. 9 and 10 are used when a still image or moving picture is stored is because it may be difficult to implement real-time processing because of the limited/specific functionality of the embedded unit 200. As mentioned previously, when the usage amount of the CPU core 209 in the embedded unit 200 is considered, these methods can minimize the load.

Also, second processing of the still images or moving pictures stored in the second SDRAM 205 can be performed by using application programs. By using a drawing function, an additional image can be overlapped, thereby generating a final result. Also, after inputting letters or adding a variety of digital effects, the images can be stored in the portable storage unit 201 or transmitted to the outside through the network module 203.

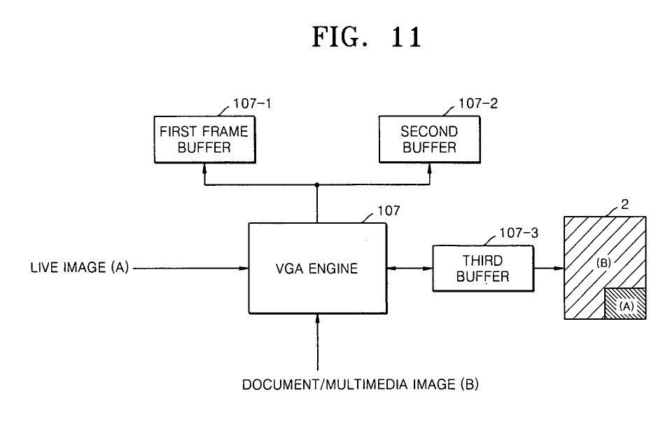

FIG. 11 is yet another block diagram illustrating features of an example image overlay apparatus of the system illustrated in FIG. 2 according to an embodiment of the present invention. Referring to FIG. 11, the image overlay apparatus includes a display unit 2, a VGA engine 107 that operates under the control of the microcontroller 109 (FIG. 2), a first frame buffer 107-1 that stores a live image A, a second frame buffer 107-2 that stores a document/multimedia image B, and a third frame buffer 107-3 that stores the live image A and the document/multimedia image B that are converted through overlay signal processing in the VGA engine 107.

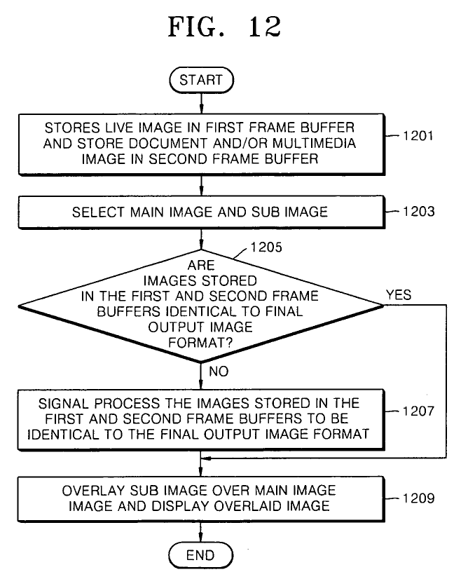

FIG. 12 is a flowchart illustrating operations of a method of overlaying an image according to an embodiment of the present invention. The method of overlaying the image illustrated in FIG. 12 will now be described with reference to FIG. 11.

Referring to FIGS. 11 and 12, in order to perform an image overlay, the VGA engine 107 stores a live image A generated in the video presenting unit 100 in the first frame buffer 107-1 under the control of the microcontroller 109 (FIG. 2), and stores a document and/or multimedia image B generated in the whole embedded unit 200 in the second frame buffer 107-2 (Operation 1201).

The VGA engine 107 stores the live image A that is input through the image sensing unit 11, the DSP 101, and the FPGA 105 in the first frame buffer 107-1. The VGA engine 107 stores the document and/or multimedia image B that is input through the portable storage unit 201 or the network module 203 and the graphic engine 207 in the second frame buffer 107-2.

The microcontroller 109 or the CPU core 209 receives a signal for selecting a main image and a sub image through the input unit (Operation 1203). For example, the microcontroller 109 may receive an input of the key input unit 16a or the remote controller 16c. According to the selecting signal, microcontroller 109 designates the main image and sub-image relative to the live image A or the document and/or multimedia image B. In another example, the CPU core 209 receives an input of the mouse 16b for selecting the main image and the sub image. The microcontroller 109 and the CPU core 209 notify each other about the selection of the main image and the sub image while performing a communication with a vertical synchronization signal as a period. For descriptive convenience, in the current embodiment the document and/or multimedia image (B) is selected as the main image and the live image (A) is selected as the sub image. However, the document and/or multimedia image (B) may be selected as the sub image and the live image (A) may be selected as the main image. During this process, the CPU core 209 transmits the size and position data of the sub image, which is to be overlaid, to the microcontroller 109.

If the selection of the main image and the sub image is finished, the microcontroller 109 determines whether the image stored in the first frame buffer 107-1 and the image stored in the second frame buffer 107-2 substantially correspond with (e.g., are identical to) a final output image format (Operation 1205).

If the image stored in the first frame buffer 107-1 and the second frame buffer 107-2 do not substantially correspond with the final output image format, the microcontroller 109 controls the VGA engine 107 to signal-process the image stored in the first frame buffer 107-1 and the image stored in the second frame buffer 107-2 so as to correspond with the final output image format (Operation 1207).

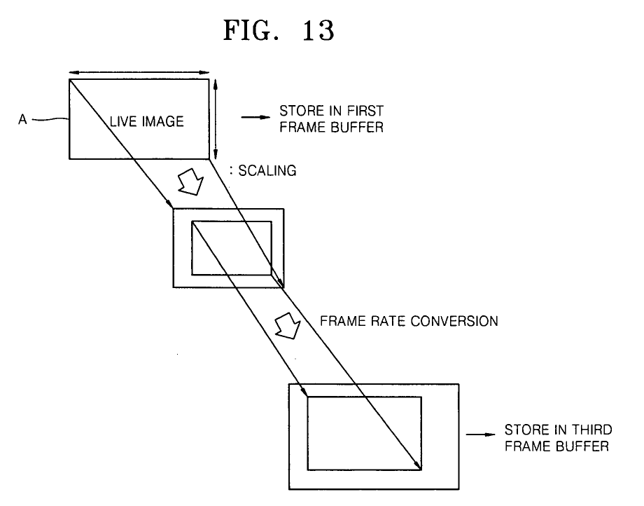

Referring to FIG. 13, the VGA engine 107 signal-processes the live image A, i.e., a sub image, to be identical to the final output image format according to the size and position data of the sub image to be overlaid that is received from the CPU core 209 under the control of the microcontroller 109. The VGA Engine 107 scales and frame rate converts the live image A stored in the first frame buffer 107-1 (FIG. 11) suitable for an overlay output, and stores the signal-processed live image A in the third frame buffer 107-3 (FIG. 11).

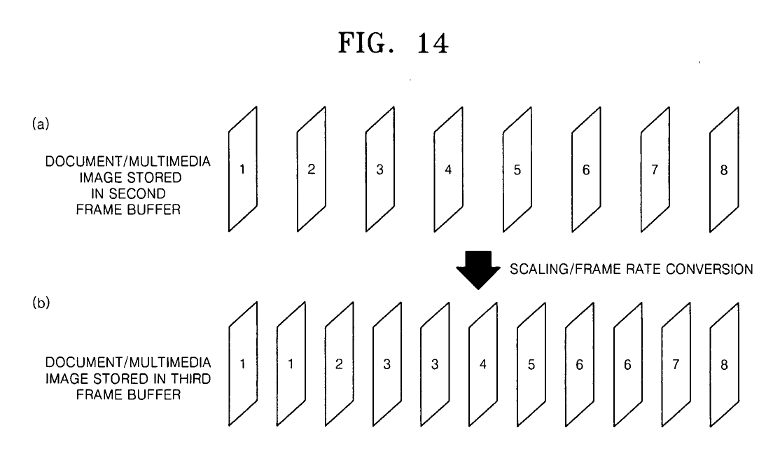

Referring to FIG. 14, the VGA engine 107 signal-processes the document/multimedia image B, i.e., a main image, so as to be identical to the final output image format under the control of the microcontroller 109. The VGA Engine 107 scales and frame rate converts the document/multimedia image B stored in the second frame buffer 107-2 (FIG. 11) so as to be identical to the final output image format, i.e., a main image format as shown in portion (a) of FIG. 6, and stores the signal-processed document/multimedia image B in the third frame buffer 107-3 (FIG. 11). For example, if the document/multimedia image B stored in the second frame buffer 107-2 is (1024×768@75 Hz), and the final output image format is (1280×1024@60 Hz), the VGA engine 107 converts the document/multimedia image B stored in the second frame buffer 107-2 to the final output image format (1280×1024@60 Hz), and stores the signal-processed document/multimedia image B in the third frame buffer 107-3 (FIG. 11).

Once the signal-processed live image A and the document/multimedia image B are completely stored in the third frame buffer 107-3 (FIG. 11), the microcontroller 109 controls an overlay function of the VGA engine 107 which causes overlay of the live image A as the sub image on the document/multimedia image B as the main image, and outputs the overlaid image on the display unit 2 (Operation 1209 FIG. 12). As shown in portion (b) of FIG. 14, the signal-processed live image A and the document/multimedia image B may be combined in an overlay configuration by, for example interleaving frames of images A and B.

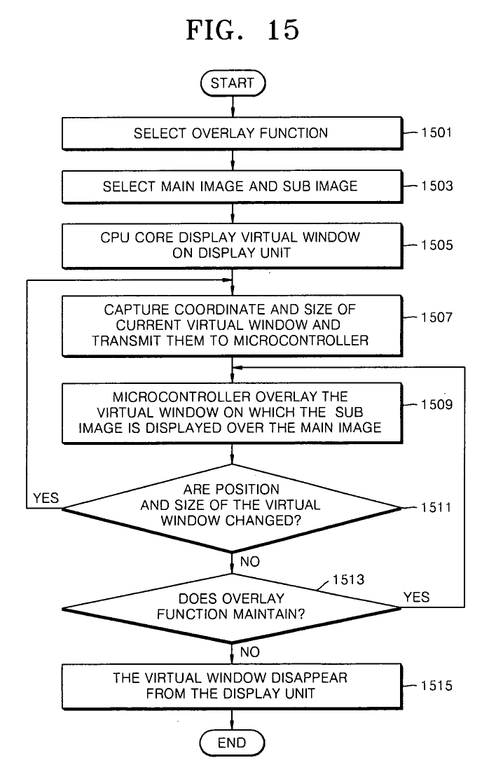

FIG. 15 is another flowchart illustrating example operations of yet another method of overlaying an image according to another embodiment of the present invention. The method of overlaying the image illustrated in FIG. 15 will now be described with reference to FIG. 11.

The CPU core 209 of the embedded unit 200 receives a signal for selecting an image overlay function through an input of the mouse 16b (Operation 1501).

If the image overlay function is selected, the CPU core 209 receives a signal for selecting a main image and a sub image through the input of the mouse 16b (Operation 1503).

The microcontroller 109 and the CPU 209 notify each other about the selection of the main image and the sub image while performing a communication using a vertical synchronization signal as a period. For descriptive convenience, in the current embodiment, a document and/or multimedia image (B) is selected as the main image and a live image (A) is selected as the sub image.

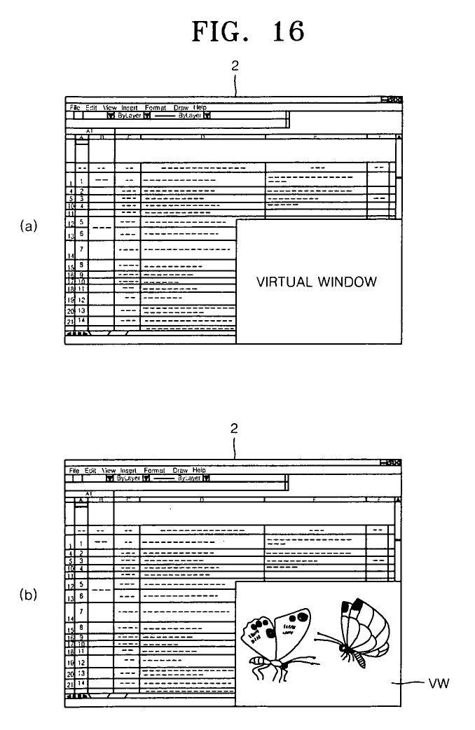

If the selection of the main image and the sub image is complete, the CPU core 209 causes a virtual window (VW) (e.g., a blank or empty window as shown in portion (a) of FIG. 16) to be formed on the display unit 2 (Operation 1505).

Referring to portion (a) of FIG. 16, the VW is overlaid on the document/multimedia image B that is selected as the main image. The VW is generated by the VGA engine 107 according to periodic communication with the microcontroller 109, which communicates with the CPU core 209. The VW can be moved or otherwise changed as desired by the user for example according to dragging and dropping operations using the mouse 16b. Also, the VW is set to have the highest property/priority so that it is located at the top (i.e., foreground) of any images being displayed.

The CPU core 209 captures or otherwise determines a coordinate and size of a current VW and transmits the coordinate and size thereof to the microcontroller 109 (Operation 1507).

The microcontroller 109 controls the VGA Engine 107 to display the VW, which is to contain live image A as the sub image, such that VW is overlaid on the document/multimedia image B, which is the main image (Operation 1509).

The microcontroller 109 receives the coordinate and size of the VW from the CPU core 209, and controls the VGA engine 107 to display the sub image on the VW. The VGA engine 107 outputs the main image on the display unit 2, outputs the sub image on the VW, and overlays the sub image on the main image under the control of the microcontroller 109. Referring to portion (b) of FIG. 16, the live image A that is selected as the sub image is displayed over the document/multimedia image B that is selected as the main image on the VW.

The CPU core 209 determines whether the coordinate and size of the VW have changed due to manipulation of the mouse 16b (Operation 151 1).

As described above, the VW can move and be changed by dragging and dropping operations using the mouse 16b. If the size and position of the VW is changed by dragging and dropping, the CPU core 209 captures a coordinate and size of the changed VW and transmits the coordinate and size thereof to the microcontroller 109. Accordingly, the microcontroller 109 controls the VGA engine 107 to adapt the sub image for display on the changed VW.

The CPU core 209 determines whether to maintain an overlay function (Operation 1513). If the overlay function is turned off, the CPU core 209 makes the VW disappear from the display unit 2 (Operation 1515).

In some embodiments the VW has a hidden property such that it disappears from the display unit 2 when the overlay function is turned off.

According to the present invention, when two images (actual live image and PC file image) generated in different sources are overlaid in one output and the overlaid image is output by mounting hardware relating to an embedded OS on an actual presenting device that does not exceed the functionality of a PC, an embedded system does not use a processor in a CPU but performs an overlay function, which does not overload the CPU of the embedded system, thereby overlaying the two images and outputting the overlaid image without a separate application program even when a multimedia image is output like the reproduction of moving pictures.

A document/multimedia file is reproduced without the PC, so that a live image and various audiovisual teaching materials can be utilized during a lesson.

For example, in a biology class including observation of an ant nest or the anatomy of a frog, related theoretical backgrounds are explained with a document image, and the actually prepared ant nest or frog is photographed as a live image on the spot, the live image and the document image are overlaid, and the overlaid image is displayed, thereby maximizing the education effect, and reproducing previously prepared moving picture audiovisual teaching materials so as to use all materials required for a modern classroom.

While the present invention has been particularly shown and described with reference to exemplary embodiments thereof, it will be understood by one of ordinary skill in the art that various changes in form and details may be made therein without departing from the spirit and scope of the present invention as defined by the following claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A video presentation system consisting of:
a display unit; and
a video presenting device connected to the display unit, the video presenting device consisting of a video presenting unit and an embedded OS unit,
wherein the video presenting unit processes a picked-up image and a received image to generate an image signal relative to an overlaid combination of the picked-up image and the received image, the video presenting unit outputting the signal to the display unit, and
wherein the embedded OS unit transmits to the video presenting unit the received image and overlay information for configuring the overlaid combination by overlaying one of the picked-up image and the received image on the other one of the picked-up image and the received image.

2. The system of claim 1, wherein the video presenting unit comprises:
an input unit receiving an input in order to execute an operation of the video presentation system;
an optical unit capturing the picked-up image;
a FPGA transmitting a frame selected from the picked-up image to the embedded OS unit for storage therein or transmission to the outside according to an image store signal of the embedded OS unit;
a VGA engine processing the picked-up image and the received image to generate the image signal for display, and outputting the image signal to the display unit; and
a first control unit periodically communicating with the embedded OS unit, and controlling the VGA engine according to a request by the input unit or the embedded OS unit.

3. The system of claim 2, wherein the VGA engine comprises:
a first buffer for storing at least one frame of the picked-up image;
a second buffer for storing the received image; and
a third buffer for combining the at least one frame of the picked-up image and the received image as the overlaid combination, and outputting the image signal representing the overlaid combination

4. The system of claim 2, wherein the video presenting unit further comprises a DSP in communication with the optical unit, the FPGA and the first control unit, the DSP outputting the picked-up image to the FPGA.

5. The system of claim 2, wherein the embedded OS unit comprises:
a second input unit receiving an input in order to execute an operation of the video presentation system;
a portable storage unit storing the received image or the picked-up image;
a network module receiving the received image from the outside or transmitting the picked-up image to the outside;
a graphic engine in communication with the VGA engine, the graphic engine processing the received image to generate a signal that can be displayed, and transmitting the signal to the VGA engine; and
a second control unit cooperating with and periodically communicating with the first control unit for controlling operation of the video presenting device.

6. The system of claim 5 wherein the first control unit operates as a host relative to an input from the first input unit and wherein the second control unit operates as a host relative to an input from the second input unit.

7. The system of claim 5 wherein the overlay information includes a size and a position of a sub image to be overlaid on a main image, wherein the second control unit transmits the overlay information to the first control unit for controlling an overlay function of the VGA engine.

8. The system of claim 7 wherein one of the picked-up image and the received image is the main image and the other one of the picked-up image and the received image is the sub image.

9. The system of claim 4 wherein the first control unit is a microcontroller and the second control unit is a CPU core having an embedded OS for executing image storage, transmission and overlay functions.

10. A method of overlaying images using a video presentation system including a video presenting unit and an embedded OS unit integral with the video presenting unit, the method comprising:
the video presenting unit capturing a live image;
the embedded OS unit receiving and storing a second image from the outside;
receiving from a user input device connected to the video presenting unit or the embedded OS unit an image overlay signal for initiating an image overlay according to the live image and the second image;
based on the image overlay signal, setting one of the live image and the second image as a main image and the other one of the live image and the second image as a sub image;
the embedded OS unit transmitting to the video presenting unit overlay information including a size and position of the sub image;
the video presenting unit combining the live image and the second image according to the overlay information;
the video presenting unit outputting to a display unit a video signal that contains the live image and the second image being in an overlaid configuration.

11. The method of claim 10, wherein the step of the video presenting unit combining the live image and the second image according to the overlay information comprises:
determining a format of the video signal; and
signal-processing the live image and the second image according to the format of the video signal.

12. The method of claim 10, wherein the step of signal-processing the live image and the second image according to the format of the video signal comprises:
determining a first frame rate of the live image;
determining a second frame rate of the second image; and
converting at least one of the live image and the second image so that the first and second frame rates are substantially similar.

13. The method of claim 10, wherein the step of the video presenting unit combining the live image and the second image according to the overlay information comprises:
storing one of the live image and the second image in a first buffer of the video presenting unit;
storing the other one of the live image and the second image in a second buffer of the video presenting unit;
determining a first frame rate of the live image that is stored in one of the first and second buffers:
determining a second frame rate of the second image that is stored in the other one of the first and second buffers;
converting at least one of the live image and the second image so that the first and second frame rates are substantially similar; and
storing in a third buffer, at least one of the live image and the second image which was converted in the converting step.

14. The method of claim 13, wherein the step of storing in a third buffer comprises interleaving frames of the live image and the second image.

15. A method of overlaying images using a video presentation system including a video presenting unit and an embedded OS unit integral with the video presenting unit, the method comprising:
the video presenting unit capturing a live image;
the embedded OS unit receiving and storing a second image from the outside;
receiving from a user input device connected to the video presenting unit or the embedded OS unit an image overlay signal for initiating an image overlay according to the live image and the second image;
based on the image overlay signal, setting one of the live image and the second image as a main image and the other one of the live image and the second image as a sub image;
the video presenting unit displaying the main image on a display unit connected to the video presenting unit;
based on the image overlay signal, the embedded OS unit commanding the video presenting unit to display on the display unit a virtual window over a portion of the main image; and
the video presenting unit displaying the sub image in the virtual window.

16. The method of claim 15, wherein the commanding step comprises:
a CPU core of the embedded OS unit transmitting size and position information of the sub image relative to the main image;
a microcontroller of the video presenting unit receiving the size and position information; and
the microcontroller controlling operation of a VGA engine for generating the virtual window according to the size and position information.

17. The method of claim 16, wherein the transmitting and receiving steps further comprise periodically communicating a vertical synchronization signal.

18. The method of claim 16, wherein the step of the video presenting unit displaying the sub image in the virtual window comprises the microcontroller controlling an image overlay function of the VGA engine.

19. The method of claim 16, wherein the step of the video presenting unit displaying the sub image in the virtual window comprises:
the CPU core transmitting to the microcontroller overlay information including a size and position of the virtual window;
the microcontroller controlling the VGA engine for combining the live image and the second image according to the overlay information;
the VGA engine outputting to the display unit a video signal that contains the live image and the second image being in an overlaid configuration.

20. The method of claim 19, wherein the step of the microcontroller controlling the VGA engine for combining the live image and the second image according to the overlay information comprises:
the microcontroller determining a format of the video signal; and
the VGA engine signal-processing the live image and the second image according to the format of the video signal.

21. The method of claim 20, wherein the step of the VGA engine signal-processing the live image and the second image according to the format of the video signal comprises:
determining a first frame rate of the live image:
determining a second frame rate of the second image; and
converting at least one of the live image and the second image so that the first and second frame rates are substantially similar.

22. The method of claim 20, wherein the step of the VGA engine signal-processing the live image and the second image according to the format of the video signal comprises:
storing one of the live image and the second image in a first buffer of the VGA engine;
storing the other one of the live image and the second image in a second buffer of the VGA engine;
the VGA engine scaling or frame rate converting at least one of the live image and the second image stored in the first and second buffers; and
the VGA engine storing in a third buffer the at least one of the live image and the second image which was scaled or frame rate converted.

23. The method of claim 22, wherein the step of the VGA engine storing in a third buffer comprises interleaving frames of the live image and the second image.

24. The method of claim 15, further comprising,
determining a size or position change of the virtual window according to a user input;
adapting the sub image to the size or position change of the virtual window as determined in the determining step.
